(19) United States
(12) Patent Application Publication
(10) Pub. No.: US 2006/0223736 A1
(43) Pub. Date: Oct. 5, 2006

(54) Dye and scent pouches and methods of making the same

(75) Inventors: John G. Lenhart, Green Bay, WI (US); John M. Knox, Chandler, AZ (US)

Correspondence Address: MICHAEL BEST & FRIEDRICH, LLP, 100 E WISCONSIN AVENUE, MILWAUKEE, WI, 53202, US

(73) Assignee: R. Lewis Technologies, Inc., Green Bay, WI (US)

(21) Appl. No.: 11/394,685

(22) Filed: Mar. 30, 2006

Related U.S. Application Data
(60) Provisional application No. 60/666,363, filed on Mar. 30, 2005.

(51) Int. Cl. C11D 17/00

(52) U.S. Cl. 510/295; 510/296

(57) ABSTRACT

Pouches comprising dyes and scents, and methods of using the pouches to deliver concentrated dyes and scents to detergents or protectants are provided. Methods of providing a customized vehicle cleaning composition using pouches comprising dyes or scents are also provided. The pouches can be used at vehicle washing sites, distributor sites or manufacturing sites to customize vehicle compositions with respect to color and scent.

### CROSS-REFERENCE TO RELATED APPLICATIONS

This application claims priority to U.S. Provisional Application No. 60/666,363 filed on Mar. 30, 2005, the entire contents of which are hereby fully incorporated by reference.

### BACKGROUND OF THE INVENTION

Dyes and scents have been added to vehicle detergents and protectants to enhance the aesthetic and organoleptic properties of detergents and protectants. Adding dyes and scents to detergents and protectants to form finished products can be a messy process that may not provide for customization. Vehicle washing sites currently use detergents and protectants that can be offered in dyed and scented versions. Since these aspects are subjective, there is no one level of scent or dye that is acceptable to all. Currently, products are made at a central site or manufacturing site and transported to the wash site. In order to remain profitable, blending facilities need to make a large volume of product at one time. The scent and dye are provided in an extremely concentrated form that is costly. When it comes to the subjective aspects of the product, the customer has limited options in terms of customization and tailoring of dyes and scents.

### SUMMARY OF THE INVENTION

In one aspect, the invention provides a pouch comprising a water-soluble film containing a composition comprising at least about 40 wt % dye.

In another aspect, the invention provides a pouch comprising a water-soluble film containing a liquid composition comprising at least about 40 wt % scent.

In yet another aspect, the invention provides a method of washing a vehicle using a customized vehicle cleaning composition. The method includes dissolving a pouch comprising a water-soluble film containing a composition comprising at least about 40 wt % dye, scent or combination thereof in a base product at a vehicle washing site to form a customized vehicle cleaning composition. The customized vehicle cleaning composition may be formed in response to a vehicle-washing customer selecting the dye, scent or combination thereof. The customer's vehicle may be washed with the customized vehicle cleaning composition at the vehicle washing site.

In a further aspect, the invention provides a method of providing a customized vehicle cleaning composition for washing vehicles to a vehicle washing site. The method includes dissolving a pouch comprising a water-soluble film containing a composition comprising at least about 40 wt % dye, scent or combination thereof in a base product at a manufacturing site or distributor site of vehicle cleaning to form a customized vehicle cleaning composition. The customized vehicle cleaning composition may be formed in response to a vehicle washing site customer selecting the dye, scent or combination thereof. The customized vehicle cleaning composition may be provided to the vehicle washing site.

In another aspect, the invention provides a customized vehicle cleaning composition for washing vehicles to a vehicle washing site. The method may comprise providing a pouch comprising a water-soluble film containing a composition comprising at least about 40 wt % dye, scent or combination thereof to the vehicle washing site. Instructions may be provided to the vehicle washing site for combining the pouch with a vehicle detergent to form a customized vehicle detergent composition.

### DETAILED DESCRIPTION OF THE INVENTION

Before any embodiments of the invention are described in detail, it is to be understood that the invention is not limited in its application to the details of construction and the arrangement of components set forth in the following description. The invention is capable of other embodiments and of being practiced or of being carried out in various ways. Also it is to be understood that the phraseology and terminology used herein is for the purpose of description and should not be regarded as limiting. The use of “including,” “comprising,” or “having” and variations thereof herein is meant to encompass the items listed thereafter and equivalents thereof, as well as additional items.

As used herein, “base product” refers to at least one of detergent, protectant and a combination thereof. In some embodiments, the base product may be at least one of undyed, unscented and a combination thereof. Suitably, the base product includes vehicle detergent compositions adapted for the cleaning or washing of vehicles. Generally, alkaline detergents, acidic detergents, neutral detergents and liquid detergents are used. Examples of protectants include, but are not limited to, drying agents, sealants, foaming products and combinations thereof. Those skilled in the art will be familiar with the detergents and protectants used in the vehicle washing industry that can be used as base product. Examples of some base products can be found in U.S. Pat. No. 6,726,779, which is hereby fully incorporated by reference.

As used herein, “vehicle washing site” refers to a retail site providing facilities and equipment for the cleaning or washing of vehicles, and where vehicles are cleaned or washed.

As used herein, the term “vehicle” refers to a device or structure for transporting persons or things, such as a car, truck or boat.

As used herein, “manufacturing site” refers to a site that makes or packages vehicle detergents or protectants.

As used herein, “distributor site” refers to a site intermediary in the supply of detergent or protectant between the manufacturing site and the vehicle washing site, which receives vehicle detergents or protectants from a manufacturing site or other distributor site, and supplies the vehicle detergents or protectants to another distributor site or to a vehicle washing site.

The invention generally provides pouches or packets containing dyes or scents that can be added to base product to form a customized vehicle cleaning composition. The dye and scent pouches of the present invention are provided in pre-measured pouches or packets that can be added to containers comprising, for example, base product on an individual basis to form a final cleaning product or a customized vehicle cleaning composition. This allows the customized composition to be scented and dyed with a minimum mess or loss of the dye or scent. This also allows the product to be customized, even at the vehicle washing site.

In other words, the pouches comprising scents and dyes can be added to or dissolved in containers comprising base product at the vehicle washing site, distributor site or manufacturing site. Therefore, instead of the manufacturing site dictating the scent and color of vehicle cleaning compositions, the cleaning compositions can be customized to individually satisfy the demand of customers at vehicle washing sites, owners of vehicle washing sites, or owners of distributor sites. In the past, manufacturing sites prepared large volumes of dyed or scented cleaning compositions on site, and then shipped portions of these to distributor sites or vehicle washing sites. Due to the large volumes, selection among color and scent was more limited. The present invention allows distributor sites and vehicle washing sites to customize their cleaning compositions by color and scent on site. Of course, manufacturing sites can also use the pouches of the present invention, which greatly alleviates the mess associated with imparting color or scent to cleaning compositions using conventional methods.

Examples of packet compositions and methods for making the same can be found, inter alia, in U.S. Pat. Nos. 4,844,828; 6,047,528; 6,090,793; 6,269,616; 6,624,130; and 6,521,581, each of which is hereby fully incorporated by reference in its entirety. Suitably, the pouch is made from a water-soluble or water-permeable film composition and can be added directly to the base product without requiring that the pouch be pierced, cut or otherwise opened. The film composition may comprise at least one of polyvinyl alcohol (PVOH), PVOH derivatives and a combination thereof. For example, a suitable film composition includes, but is not limited to, MonoSol M8630, available from MonoSol LLC, Merrillville, Ind. Some packets or pouches of the present invention may be commercially available from Cloud Corporation or Cloud Packaging Solutions, Des Plaines, Ill.

The pouches are to be used primarily in the vehicle-cleaning industry, to add scent or dye to detergents that are suitable for cleaning or washing vehicles. The dyes and scents may be pouched in amounts of at least about 0.25 ounce, particularly, at least about 0.5 ounce, and more particularly, at least about 1 ounce. The dyes and scents may be pouched in amounts of less than about 20 ounces, particularly, less than about 15 ounces, and more particularly, less than about 12 ounces or 10 ounces. The packet or pouch may contain or comprise a variety of dyes and scents. Suitable dyes may be water-soluble. Examples of suitable dyes include liquid polymer dyes and powder dyes. Other suitable dyes may include, but are not limited to, acridine; acridone (including anthraquinone and pyrene); arylmethane; azo; diazonium; nitro; phthalocyanine; quinone imine; tetrazolium; thiazole; xanthene and combinations thereof. Dyes may include, but are not limited to, at least one of blue, yellow, red liquid dyes and combinations thereof. Suitable dyes may be obtained from Chromatech, Canton, Mich. The pouches or packets of the invention may comprise dyes known in the art and typically used for detergents or protectants, particularly, detergents and protectants for vehicles. The dyes contained within the pouches are generally liquid concentrated dyes or powder concentrated dyes. As used herein, a “concentrated dye” when contained within a pouch means a composition comprising at least about 40 wt % dye. The dye component contained within the pouch is suitably present in amounts of at least about 0.5 wt %, at least about 1 wt %, at least about 2 wt %, at least about 5 wt %, at least about 10 wt %, at least about 15 wt %, at least about 20 wt %, at least about 30 wt %, at least about 40 wt %, at least about 50 wt %, at least about 60 wt %, at least about 70 wt %, at least about 80 wt %, at least about 90 wt %, and at least about 99 wt % of the pure dye component in liquid or solid form per total weight of the component contained within the pouch. Those skilled in the art will be familiar with the dyes used in the vehicle washing industry.

Examples of scents include, but are not limited to, scents typically used for vehicle detergents and protectants, e.g., pina colada, cherry, lemon, vanilla, blueberry, citrus, tutti frutti and orange fragrances. The scents can comprise a variety of different components which are blended together to produce the desired fragrance. Other scents and dyes may be known to those skilled in the art. The scents are generally liquid concentrated scents. As used herein, a “concentrated scent” when contained within a pouch means a composition comprising at least 40 wt % scent. The scent component contained within the pouch is suitably present in amounts of at least about 2 wt %, at least about 5 wt %, at least about 10 wt %, at least about 15 wt %, at least about 20 wt %, at least about 30 wt %, at least about 40 wt %, at least about 50 wt %, at least about 60 wt %, at least about 70 wt %, at least about 80 wt %, at least about 90 wt % or at least about 99 wt % of the scent component per total weight of the component contained within the pouch. Those skilled in the art will be familiar with scents used in the vehicle washing industry.

The dyes and scents contained within the pouches or packets may also include water. Water may be present in an amount sufficient to ensure that the dye and scent components will dissolve or disperse once the pouch is added to the base product, and to ensure that the film component of the pouch does not degrade, dissolve or disperse during storage or transportation of the pouch. Suitable amounts of water include at least about 1%, at least about 2%, at least about 5%, at least about 10%, at least about 20%, and less than about 80%, less than about 70%, less than about 60%, less than about 50%, less than about 40% and less than about 30% per total volume of the component contained within the pouch.

Other ingredients such as surfactants, solvents, salts, acids, bases may optionally be added to the dyes or scent components to modify their solubility with the film or outer packet. The dyes and scents may be water-soluble so that each can be dissolved in the base product. Scents that are partially or completely oil-soluble may be combined with sufficient surfactant to ensure that they solubilize in the base product. Suitable surfactants include, but are not limited to, anionic, nonionic, cationic, ampholytic and zwitterionic surfactants or mixtures thereof. Examples of surfactants are provided in U.S. Pat. Nos. 4,259,217; 4,222,905; 4,260,529; 4,228,042; 4,228,044; 3,457,109; 3,222,201; 3,222,213; 3,717,630; 3,332,880; 4,284,435; 4,111,855; and 4,865,773, each of which is hereby fully incorporated by reference. The amount of surfactant may be selected sufficient to ensure that the scent dissolves or disperses in the base product, but which does not result in degradation or solubilization of the pouch. Suitable amounts of surfactant include at least about 1 wt %, at least about 2 wt %, at least about 5 wt %, at least about 10 wt %, at least about 15 wt %, at least about 20 wt %, at least about 25 wt %, or at least about 30 wt % by weight of the total component contained within the pouch, and less than about 75 wt %, less than about 65 wt %, less than about 55 wt %, less than about 50 wt %, less than about 45 wt %, less than about 40 wt % or less than about 35 wt % by weight of the total component contained within the pouch. Suitably, the dyes and scents do not solubilize the pouch or packet.

Pouches containing the dyes and/or scents can be added to the base product and mixed to disperse the contents of the pouch into the base product. In one embodiment, a solution may be sprayed on the packet or pouch before adding the pouch to the base product, to facilitate dispersion of packet or pouch in the base product. Suitable solutions include those of acidic pH, such as containing citric acid or acetic acid, those of alkaline pH, or those comprising other components that would expedite the dispersion of the water-soluble film into the base product. Mixing may be accomplished, for example, by stirring with a mixer, shaking, or through dissolution and dispersion during transportation.

### EXAMPLES

### Example 1

### Compatibility of MonoSol M860 Water-Soluble Film with Liquitint Blue EA

A pouch made from the polyvinyl alcohol based water-soluble film, MonoSol M8630 (thickness 76 micrometers), was tested for compatibility with Liquitint Blue EA (Chromatech, MI), a blue liquid pure polymer dye. The Liquitint Blue EA comprised 100% dye. The film successfully contained the dye. Alterations in chemical structure of the film were measured by Fourier Transform Infrared (FTIR) spectroscopy over the containment period of 60 days at ambient temperature and humidity. Little to no disintegration or alteration of the chemical structure was noted. Faint blue film discoloration and a slight reduction in flexibility of the film were observed. Calculated moisture values suggested the dye was likely responsible for slight dehydration of the film.

Solubility of the film was also tested at 10° C. in distilled water. The containment of the dye by the film for 60 days at ambient temperature and humidity did not significantly alter the solubility of the film. Evaluation of collected infrared spectra revealed the reaction ratio within M8630, necessary for maintenance of solubility, remained within limits established for virgin film. Plasticizer content, based on spectral area measurements, suggested a maximum reduction of 12%.

### Example 2

### Compatibility of MonoSol M8630 Water-Soluble Film with Liquitint Red XC

A pouch made from the polyvinyl alcohol based water-soluble film, MonoSol M8630 (thickness 76 micrometers), was tested for compatibility with Liquitint Red XC (Chromatech, MI), a red liquid pure polymer dye. The Liquitint Red XC comprised 100% dye. The film successfully contained the dye. Alterations in chemical structure of the film were measured by Fourier Transform Infrared (FTIR) spectroscopy over the containment period of 60 days at ambient temperature and humidity. Little to no disintegration or alteration of the chemical structure was noted. Faint red film discoloration and a slight reduction in flexibility of the film were observed. Calculated moisture values suggested the dye was likely responsible for slight dehydration of the film.

Solubility of the film was also tested at 110° C. in distilled water. The containment of the dye by the film for 60 days at ambient temperature and humidity did not significantly alter the solubility of the film. Evaluation of collected infrared spectra revealed the reaction ratio within M8630, necessary for maintenance of solubility, remained within limits established for virgin film. Plasticizer content, based on spectral area measurements, suggested a maximum reduction of 14%.

### Example 3

### Compatibility of MonoSol M8630 Water-Soluble Film with Liquitint Yellow EC

A pouch made from the polyvinyl alcohol based water-soluble film, MonoSol M8630 (thickness 76 micrometers), was tested for compatibility with Liquitint Yellow EC (Chromatech, MI), a yellow liquid pure polymer dye. The Liquitint Yellow EC comprised 100% dye. The film successfully contained the dye. Alterations in chemical structure of the film were measured by Fourier Transform Infrared (FTIR) spectroscopy over the containment period of 60 days at ambient temperature and humidity. Little to no disintegration or alteration of the chemical structure was noted. Faint yellow film discoloration and a slight reduction in flexibility of the film were observed. Calculated moisture values suggested the dye was likely responsible for slight dehydration of the film.

Solubility of the film was also tested at 10° C. in distilled water. The containment of the dye by the film for 60 days at ambient temperature and humidity did not significantly alter the solubility of the film. Evaluation of collected infrared spectra revealed the reaction ratio within M8630, necessary for maintenance of solubility, remained within limits established for virgin film. Plasticizer content, based on spectral area measurements, suggested a maximum reduction of 8%.

### Example 4 (Prophetic)

### Compatibility of MonoSol M860 Water-Soluble Film with Liquitint Blue EA (Chromatech, MI)

A suitably-sized pouch made from the polyvinyl alcohol based water-soluble film, MonoSol M8630 (thickness 76 micrometers) is tested for compatibility with 2 ounces of Liquitint Blue EA (Chromatech, MI), a blue liquid pure polymer dye. The Liquitint Blue EA comprises 100% dye. The film is expected to successfully contain the dye. Alterations in chemical structure of the film are measured by Fourier Transform Infrared (FTIR) spectroscopy over the containment period of 60 days at ambient temperature and humidity. Little to no disintegration or alteration of the chemical structure is expected. Faint blue film discoloration and a slight reduction in flexibility of the film may be expected.

Solubility of the film is also tested at 10° C. in distilled water. The containment of the dye by the film for 60 days at ambient temperature and humidity is expected not to significantly alter the solubility of the film. Evaluation of collected infrared spectra will reveal the reaction ratio within M8630, necessary for maintenance of solubility, and is expected to remain within limits established for virgin film.

### Example 5 (Prophetic)

### Compatibility of MonoSol M8630 Water-Soluble Film with Liquitint Red XC (Chromatech, MI)

A suitably-sized pouch made from the polyvinyl alcohol based water-soluble film, MonoSol M8630 (thickness 76 micrometers), is tested for compatibility with 5 ounces of Liquitint Red XC (Chromatech, MI), a red liquid pure polymer dye. The Liquitint Red XC comprises 100% dye. The film is expected to successfully contain the dye. Alterations in chemical structure of the film are measured by Fourier Transform Infrared (FTIR) spectroscopy over the containment period of 60 days at ambient temperature and humidity. Little to no disintegration or alteration of the chemical structure is expected. Faint red film discoloration and a slight reduction in flexibility of the film may be expected.

Solubility of the film is also tested at 10° C. in distilled water. The containment of the dye by the film for 60 days at ambient temperature and humidity is not expected to significantly alter the solubility of the film. Evaluation of collected infrared spectra will reveal the reaction ratio within M8630, necessary for maintenance of solubility, and is expected to remain within limits established for virgin film.

### Example 6 (Prophetic)

### Compatibility of MonoSol M8630 Water-Soluble Film with Liquitint Yellow EC (Chromatech, MI)

A suitably-sized pouch made from the polyvinyl alcohol based water-soluble film, MonoSol M8630 (thickness 76 micrometers), is tested for compatibility with 10 ounces of Liquitint Yellow EC (Chromatech, MI), a yellow liquid pure polymer dye. The Liquitint Yellow EC comprises 100% dye. The film is expected to successfully contain the dye. Alterations in chemical structure of the film are measured by Fourier Transform Infrared (FTIR) spectroscopy over the containment period of 60 days at ambient temperature and humidity. Little to no disintegration or alteration of the chemical structure is expected. Faint yellow film discoloration and a slight reduction in flexibility of the film may be expected.

Solubility of the film is also tested at 110° C. in distilled water. The containment of the dye by the film for 60 days at ambient temperature and humidity does not significantly alter the solubility of the film. Evaluation of collected infrared spectra will reveal the reaction ratio within M8630, necessary for maintenance of solubility, and is expected to remain within limits established for virgin film.

### Example 7 (Prophetic)

### Use of Pouches in Examples 1-6 in Base Product

The pouches of Examples 1-6 are dissolved in base products to impart color. Base products, which are generally dyed or scented in the art using conventional dyeing or scenting methods, can be used. Depending upon the amount of base product to be dyed or scented, one skilled in the art can easily ascertain the amount of dye or scent to be pouched, and the amount of film required to pouch the dye or scent. The base product may or may not be dyed or scented before the pouch is added.

While the present invention has now been described and exemplified with some specificity, those skilled in the art will appreciate the various modifications, including variations, additions, and omissions that may be made in what has been described. Accordingly, it is intended that these modifications also be encompassed by the present invention and that the scope of the present invention be limited solely by the broadest interpretation that lawfully can be accorded the appended claims.

All patents, publications and references cited herein are hereby fully incorporated by reference. In case of conflict between the present disclosure and incorporated patents, publications and references, the present disclosure should control.

What is claimed is:

1. A pouch comprising a water-soluble film containing a composition comprising at least about 40 wt % dye.

2. The pouch of claim 1, wherein the dye comprises a liquid polymer dye.

3. The pouch of claim 1, wherein the composition is a liquid composition, and the liquid composition comprises at least about 90 wt % dye.

4. The pouch of claim 1, wherein the water-soluble film comprises at least one of a polyvinyl alcohol, a polyvinyl alcohol derivative and a combination thereof.

5. A pouch comprising a water-soluble film containing a liquid composition comprising at least about 40 wt % scent.

6. The pouch of claim 5, wherein the liquid composition further comprises a surfactant.

7. The pouch of claim 6, wherein the liquid composition comprises about 1 wt % to about 50 wt % surfactant.

8. The pouch of claim 5, wherein the water-soluble film comprises at least one of a polyvinyl alcohol, a polyvinyl alcohol derivative and a combination thereof.

9. A method for making a dyed detergent composition for cleaning vehicles comprising dissolving the pouch of claim 1 in a base product to form a dyed detergent composition for cleaning vehicles.

10. The method of claim 9, wherein the base product comprises a vehicle washing detergent.

11. The method of claim 9, further comprising mixing or shaking the dyed detergent composition to disperse the composition in the base product.

12. The method of claim 9, wherein the composition comprises a liquid polymer dye.

13. A method for making a scented detergent composition for cleaning vehicles comprising dissolving the pouch of claim 6 in a base product to form a scented detergent composition for washing vehicles.

14. The method of claim 13, wherein the base product comprises a vehicle washing detergent.

15. The method of claim 14, further comprising mixing or shaking the scented detergent composition to disperse the liquid composition in the base product.

16. The method of claim 15, wherein the liquid composition comprises a surfactant and water.

17. A method of washing a vehicle using a customized vehicle cleaning composition, the method comprising:
dissolving a pouch comprising a water-soluble film containing a composition comprising at least about 40 wt % dye, scent or combination thereof in a base product at a vehicle washing site to form a customized vehicle cleaning composition, the customized vehicle cleaning composition being formed in response to a vehicle-washing customer selecting the dye, scent or combination thereof; and
washing the customer's vehicle with the customized vehicle cleaning composition at the vehicle washing site.

18. The method of claim 17, wherein the composition comprises a dye.

19. The method of claim 17, wherein the composition comprises a scent.

20. The method of claim 17, wherein the base product is unscented or undyed.

21. A method of providing a customized vehicle cleaning composition for washing vehicles to a vehicle washing site, the method comprising:
dissolving a pouch comprising a water-soluble film containing a composition comprising at least about 40 wt % dye, scent or combination thereof in a base product at a manufacturing site or distributor site of vehicle cleaning to form a customized vehicle cleaning composition, the customized vehicle cleaning composition being formed in response to a vehicle washing site customer selecting the dye, scent or combination thereof; and
providing the customized vehicle cleaning composition to the vehicle washing site.

22. The method of claim 20, wherein the composition comprises a dye.

23. The method of claim 20, wherein the composition comprises a scent.

24. The method of claim 21, wherein the base product is unscented or undyed.

25. The method of claim 21, wherein the customized cleaning composition is formed at a distributor site.

26. A method of providing a customized vehicle cleaning composition for washing vehicles to a vehicle washing site, the method comprising:
providing a pouch comprising a water-soluble film containing a composition comprising at least about 40 wt % dye, scent or combination thereof to the vehicle washing site; and
providing instructions to the vehicle washing site for combining the pouch with a vehicle detergent to form a customized vehicle detergent composition.

27. The method of claim 23, wherein the composition comprises a dye.

28. The method of claim 23, wherein the composition comprises a scent.

29. The method of claim 26, wherein the base product is unscented or undyed.
